(19) United States
(12) Patent Application Publication
(10) Pub. No.: US 2008/0203347 A1
(43) Pub. Date: Aug. 28, 2008

(54) CONTROL VALVE FOR A GAS DIRECT INJECTION FUEL SYSTEM

(76) Inventors: Santos Burrola, Cd. Juarez (MX); Alejandro Moreno, El Paso, TX (US)

Correspondence Address: DELPHI TECHNOLOGIES, INC., M/C 480-410-202, PO BOX 5052, TROY, MI, 48007, US

(21) Appl. No.: 11/680,598

(22) Filed: Feb. 28, 2007

(51) Int. Cl. F16K 51/00

(52) U.S. Cl. 251/284

(57) ABSTRACT

A control valve for a gas direct injection fuel delivery system is provided. The control valve comprises a valve body, a poppet movably received within the valve body, and an actuator disposed within the valve body. The valve body has a first fluid path, a second fluid path, and a valve seat providing fluid communication therebetween. The poppet is capable of movement between a first position and a second position. When disposed in the first position, the poppet seals the valve seat to block fluid communication between the first fluid path and the second fluid path. The poppet permits fluid communication between the first fluid path and the second fluid path as the poppet moves from the first position to the second position. The poppet is configured so that a pressure in the first fluid path produces a force that tends to move the poppet toward the second position and a pressure in the second fluid path produces a force that tends to move the poppet toward the first position. The actuator is configured to transition between an activated and a de-activated state. The actuator prevents the poppet from being disposed in the first position when in the de-activated state and the pressure in the second fluid path does not exceed the pressure in the first fluid path by at least a first pressure differential. The actuator permits the poppet to be disposed in the first position when in the activated state.

### BACKGROUND

Exemplary embodiments of the present invention generally relate to fuel injection systems for internal combustion engines. More particularly, exemplary embodiments of the present invention relate to control valves for controlling the pressure and/or flow of a fluid delivered to injector valves in an engine.

For many decades, gasoline internal combustion engines employed a carburetor to mix fuel with incoming air. The resulting air/fuel mixture was distributed through an intake manifold and mechanical intake valves to each of the engine cylinders. For most engines, the carburetion systems have been replaced by multi-port fuel injection systems. In a multi-port fuel injection system, there is a separate fuel injector valve that injects gasoline under pressure into the intake port at each cylinder where the gasoline mixes with air flowing into the cylinder. Even with multi-port fuel injection, however, there are limits to the fuel supply response and combustion control that can be achieved.

More recently, a third approach to supplying fuel into the engine cylinders has been devised. This technique, known as “gasoline direct injection” or “GDI”, injects the fuel directly into the combustion cylinder through a port that is separate from the air inlet passage. Thus, the fuel does not premix with the incoming air, thereby allowing more precise control of the amount of fuel supplied to the cylinder and the point during the piston stroke at which the fuel is injected. GDI systems provide higher power output and efficiency with lower fuel consumption.

Specifically, when the engine operates at higher speeds or higher loads, fuel injection occurs during the intake stroke to optimize combustion under those conditions. During normal driving conditions, fuel injection happens at a latter stage of the compression stroke and provides an ultra-lean air to fuel ratio for relatively low fuel consumption. Because the fuel may be injected while high compression pressure exists in the cylinder, gasoline direct injection requires that the fuel be supplied to the injector valve at a very high pressure. It has also been determined that increasing the injection pressure has a great impact on fuel economy and emissions through its effects on fuel “atomization,” that is, delivery of the fuel in such a way that it easily mixes with the air in the chamber and penetrates the compressed air in the combustion chamber.

The most important characteristics of a direct injection system are high-pressure generation and supply, exact control of injection timing and injected fuel quantity, and thorough fuel dispersion and mixture preparation together with the in-cylinder charge motion. In particular, the desire to increase pressure injection pressures and thereby transfer the quantity of fuel into the cylinder within more limited time periods has had a major influence on system design. Modern fuel injection pressures range from 135-200 Bars (2000 to 2900 Psi) and are expected to continue to increase. Thus, the fuel system must be capable of handling these high pressures while still providing accurate precise injection timing and metering.

Electromechanical actuators are used in vehicle applications to activate valves that control the flow and/or pressure of supplied fluid through one or more fluid passages. In many systems, such a valve will provide pressure or flow output control that is proportional to an input electrical signal that is provided to the electromechanical actuator. The signal is provided by an engine computer that determines the optimum valve timing based on the operating conditions occurring at any given point and time. These conditions can include, for example, engine speed, engine load, the amount of fuel required, and other factors, particularly the angle of the cam when the fuel is supplied by a piston pump that is directly operated by a camshaft.

In more specialized systems, the actuator and valve design must be customized to meet the needs of the application such as, for instance, the very fast switching requirements and tight variation tolerances in response time of the high pressure injection cycle in a gas direct injection system. Thus, the control valve is a critical element in the proper operation of the engine. The control valve must adequately manage the magnetic, mechanical, and hydraulic forces to produce the desired fuel pressure and/or flow rate. Factors such as friction, hydraulic stiction, component misalignment, under-over damping, inertia, and mass, among others, should be minimized to reduce actuator performance variation and enhance part reliability.

Accordingly, it is desirable to provide a flow control valve for a fuel system that is capable of handling these high pressures while still providing extremely fast, accurate, and precise regulation of injection timing and metering.

### SUMMARY OF THE INVENTION

In accordance with exemplary embodiments of the present invention, a control valve for a gas direct injection fuel delivery system is provided. The control valve comprises a valve body, a poppet movably received within the valve body, and an actuator disposed within the valve body. The valve body has a first fluid path, a second fluid path, and a valve seat providing fluid communication therebetween. The poppet is capable of movement between a first position and a second position. When disposed in the first position, the poppet seals the valve seat to block fluid communication between the first fluid path and the second fluid path. The poppet permits fluid communication between the first fluid path and the second fluid path as the poppet moves from the first position to the second position. The poppet is configured so that a pressure in the first fluid path produces a force that tends to move the poppet toward the second position and a pressure in the second fluid path produces a force that tends to move the poppet toward the first position. The actuator is configured to transition between an activated and a de-activated state. The actuator prevents the poppet from being disposed in the first position when in the de-activated state and the pressure in the second fluid path does not exceed the pressure in the first fluid path by at least a first pressure differential. The actuator permits the poppet to be disposed in the first position when in the activated state.

### BRIEF DESCRIPTION OF THE DRAWINGS

FIG. 1 is a schematic illustration of an exemplary gas direct engine system layout;

FIG. 2 is a side view of an exemplary embodiment of a control valve in accordance with the present invention;

FIG. 3 is a cross sectional view of the exemplary control valve of FIG. 2 with the valve shown in a fully open position;

FIG. 4 is a cross sectional view of the exemplary control valve of FIG. 2 with the valve shown between a fully open position and a closed position;

FIG. 5 is a cross sectional view of the exemplary control valve of FIG. 2 with the valve shown in a closed position;

FIG. 6 is a partial cross-sectional view of the control passage of the exemplary control valve of FIG. 2 in the fully open position of FIG. 3;

FIGS. 7a and 7b are side views of an exemplary poppet;

FIG. 8 is a side view of an exemplary armature; and

FIG. 9 is a graphical illustration of a metering cycle during operation of an exemplary gas direct injection system.

### DETAILED DESCRIPTION OF EXEMPLARY EMBODIMENTS

Exemplary embodiments of the present invention illustrated in the attached drawings relate to control valves for controlling the flow and/or pressure of fluid through a fluid path during a high-pressure fluid supply pump's fuel metering cycle. The description in the following specification relates to the exemplary embodiments illustrated in the attached drawings, but it is to be understood that the present invention is not limited to the specific embodiments disclosed herein and may assume various alternative orientations and applications. The specific devices and processes illustrated in the attached drawings and described in the following specification are simply exemplary embodiments of the inventive concepts disclosed herein. Therefore, it should be understood that specific dimensions, orientations, applications, and other physical characteristics relating to the embodiments disclosed herein are not considered to be limiting.

With initial reference to FIG. 1, an exemplary embodiment of a direct gasoline injection (GDI) fuel system 1 for the engine of a motor vehicle has an electric feed pump 2 located in or adjacent to the fuel tank 3. Feed pump 2 forces gasoline through fuel line 4 at a relatively low pressure (for example, 2-6 bar) to an inlet line 5 of a supply pump 6 located near the engine. In exemplary embodiments, supply pump 6 can be driven by a pulley or directly by the engine camshaft to receive and deliver fuel according to the angle of a cam during rotation of the camshaft. The camshaft can, in turn, be driven by the engine's crankshaft through timing belts, gears, or chains. For example, supply pump 6 can comprise a positive displacement piston pump in which the rotation of the camshaft causes a piston to move into and out of the pump's supply chamber, and thereby increase and decrease the volume of the supply chamber. In this case, the downward (or suction) stroke of the piston causes low pressure in the supply chamber, creating a partial vacuum that draws fuel being fed from fuel tank 3 through inlet line 5 into the supply chamber.

This latter supply pump 6 can then generate a force to furnish the gasoline under high pressure (for example, 120-250 bar) through a pump outlet line 7 that is joined to the pump chamber to a high-pressure common fuel rail 8, which feeds a plurality of individual fuel injectors 11 for the engine cylinders. Common rail 8 is open only when the supply pressure is above the high operating pressure of the rail, as determined by a high-pressure sensor 9. A standard mechanical pressure relief valve 13 is provided in parallel with supply pump 6 to relieve any dangerously high pressure from occurring in pump outlet line 7 (for instance, if common rail 8 is inadvertently closed while the pump is running). Relief valve 13 can be set below the maximum pressure rating that the piping, tubing, or any other components can withstand.

In accordance with an exemplary embodiment of the present invention, a control valve 10 controls fluid communication between low-pressure fuel tank 3 and the chamber of the supply pump 6, and manages the instantaneous outlet pressure of the supply pump by diverting and modulating the pressure of the discharge gasoline flow in pump inlet and outlet lines 5, 7. Specifically, control valve 10 remains open so that fuel can be fed to the chamber of supply pump 6 and to relieve the high pressure at pump outlet line 7 by returning the gasoline to lower pressure inlet line 5 for the pump. Control valve 10 closes so that supply pump 6 can pressurize fuel within the pump chamber and delivery fuel to injectors 11 at precise, adjustable flow rates. In the example in which supply pump 6 is driven by a piston, when the piston moves upward (the discharge stroke), the mechanical energy of the piston transfers pressure energy to the fuel in the supply chamber so that the fuel is pressurized. This pressurized fuel, in addition to forcing common rail 8 to open, can force control valve 10 to remain closed while being delivered to the common rail.

Therefore, control valve 10 is normally open and closes when an electrical actuator is energized or when needed to create the desired loading, spilling, and pumping flow conditions of the GDI system, as will be described in greater detail in the exemplary embodiments presented below. As with supply pump 6, the operation of control valve 10 can be synchronized with the camshaft so that the valve can be activated according to the angle of the cam and the desired flow and/or pressure of fuel being delivered to the injectors.

The timing and duration of electrical activation and the operation of the supply pump are controlled by the engine management system that includes an electronic control unit (ECU) (not shown) for controlling the flow of gasoline through control valve 10. The ECU, which can comprise a microprocessor to provide real-time processing, monitors engine-operating parameters via various sensors and interprets these parameters to calculate the appropriate amount of fuel to be injected for each individual injection event. The optimum amount of injected fuel can depend on conditions such as engine and ambient temperatures, engine speed and workload, and exhaust gas circulation. The timing of fuel injection can then depend on the amount of fuel desired for delivery and, in the example of a piston-driven supply pump, the current angle of the cam operating on the piston, which determines the volume of fuel that the supply chamber can hold at a given moment. The ECU also electrically operates the fuel injectors 11, which act as fuel-dispensing nozzles to inject fuel directly into the engine's air stream.

During steady state operation above the idle speed of the engine, the fuel injections from exemplary GDI system 1 into the cylinders are discrete events, beginning at regular time intervals and having substantially identical duration. During each injection event, control valve 10 will close so that pressure in pump outlet line 7 rises so that fuel can be supplied at the desired high-pressure level (for example, 200 bar) to fuel injectors 11. Between fuel injection events, control valve 9 will open so that fuel can be fed from fuel tank 3 to load supply pump 6 for the next injection event. Control valve 10 will also remain open between loading pumping so that fuel can be expelled from the supply chamber through the valve back to fuel line 4 and return through the valve to the supply chamber during rotation of the camshaft. While the injection event, control valve activation, and high-pressure delivery of fuel by the supply pump are all substantially controlled by the ECU, they are not synchronized with one another and do not occur exactly simultaneously, as will be described with reference to the exemplary embodiments below. U.S. Pat. No. 6,494,182, the contents of which are incorporated herein by reference thereto, describes the operation of a type of gasoline direct injection system that can utilize the exemplary control valves described below.

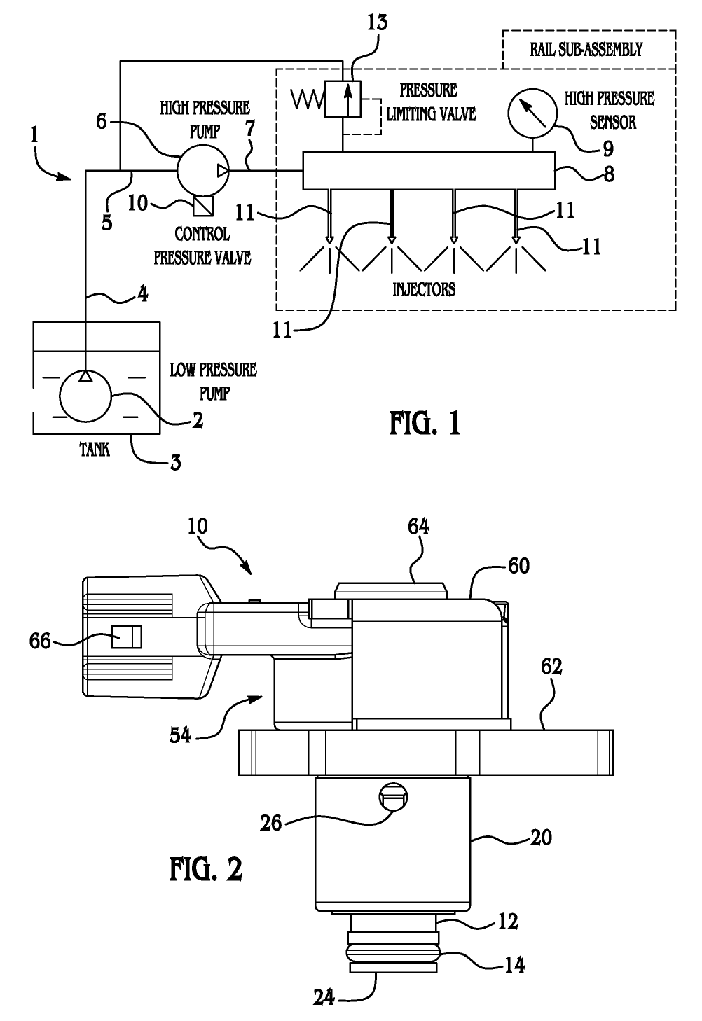

With reference now to FIGS. 2 and 3, an exemplary embodiment of control valve 10 from FIG. 1 is illustrated. Exemplary control valve 10 can be employed to control fluid flowing between a fuel tank and the inlet and outlet lines of a fuel supply pump such as, for example, supply pump 6 in the exemplary GDI system of FIG. 1. Control valve 10 is configured to mount within an aperture in the body of the supply pump. Control valve 10 has a tubular valve housing or stem 20 from which an annular end flange 12 extends. End flange 12 is configured to be inserted into the aperture of a supply pump so as to interface with the pump's inlet and outlet lines and permit control valve 10 to control fuel flow to and from the pump. End flange 12 is provided with an annular o-ring seal 14 on its external surface that seals against the internal surface of the supply pump aperture to prevent seeping of fuel from the inlet and outlet lines of the pump.

A longitudinal bore 16 extends through the respective bodies of valve stem 20 and end flange 12 jointly to provide fluid communication between an outlet fluid passage 18 and an inlet fluid passage 22. Bore 16 includes a region 16a of enlarged diameter, a region 16b of reduced diameter, and a region 16c of further reduced diameter. An outlet port 24 is formed as an open end of bore region 16c at end flange 12. Outlet port 24 that communicates with outlet passage 18, and a transverse inlet port 26 opens into bore 26 to communicate with inlet passage 22, which extends transversely into the bore. Thus, outlet passage 18 is configured to extend between the inlet and outlet lines of a fuel supply pump and a control chamber 32 within bore region 16c, while inlet passage 22 is configured to extend transversely from bore region 16b to connect to a fuel inlet line carrying from the fuel tank of an engine.

A valve seat 28 that is integral formed with valve stem 20 proximate to inlet passage 22 extends transversely from the valve stem into the bore between regions 16b and 16c. Valve seat 28 has an orifice 30 that opens into control chamber 32, which is located between outlet passage 18 and inlet passage 22 within bore region 16c. A valve poppet 34 is slidably received within control chamber 32 and moves with respect to valve seat 28 and a valve stop 46 between outlet passage 18 and inlet passage 22.

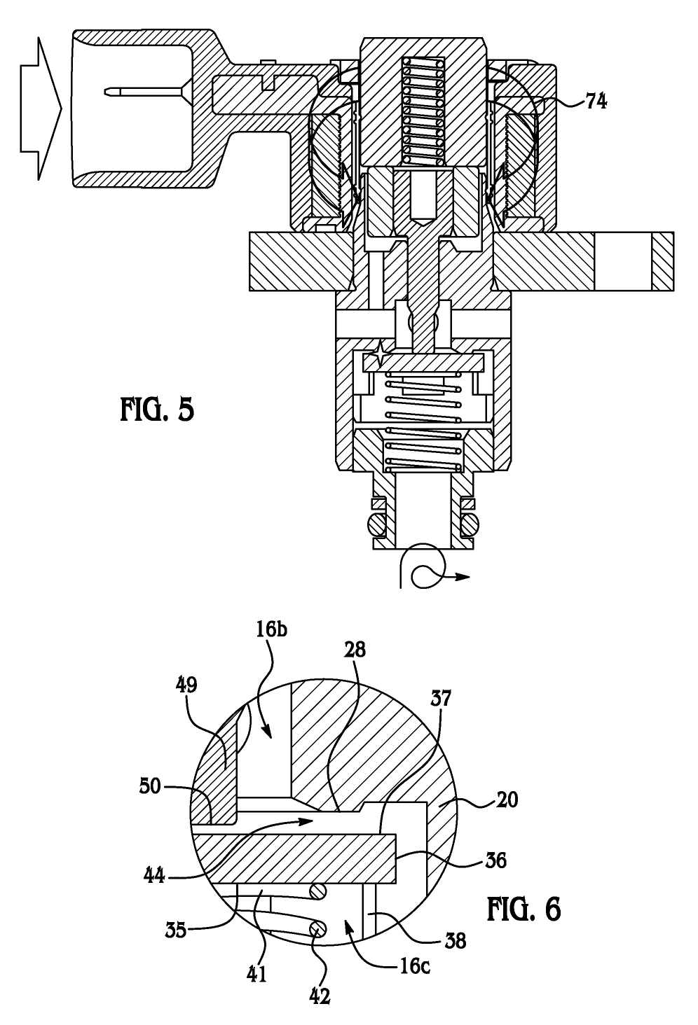

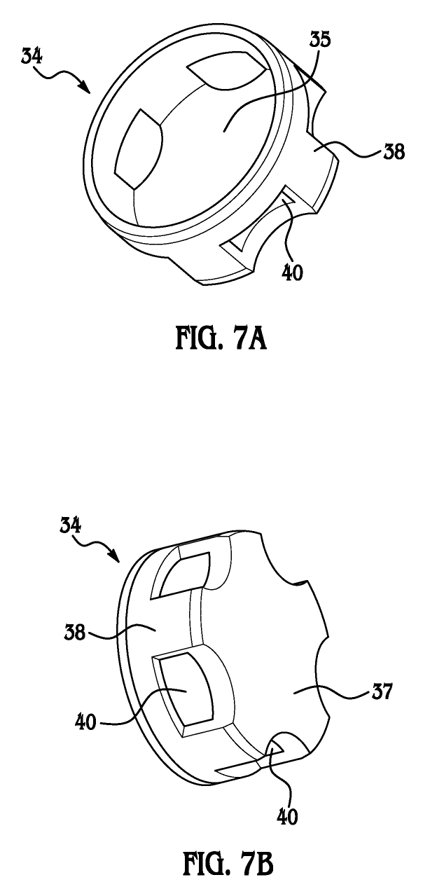

In the present exemplary embodiment, poppet 34 is cup-shaped with a generally round disk 36 and a generally annular sidewall 38 extending longitudinally therefrom, as illustrated in FIGS. 7a and 7b. In alternative embodiments, disk 36 and sidewall 38 can also be generally rectangular, star shaped, or another preferred shape. Disk 36 has a top surface 37 that is exposed to orifice 30 and inlet passage 22 and a bottom surface 35 that is exposed to control chamber 32. A plurality of grooves 40 extend longitudinally from the periphery of disk 36 along sidewall 38 and permit fluid flow between inlet passage 22 and control chamber 32 on opposite sides of poppet 34 when control valve 10 is open, as will be described in detail below. The ends of grooves 40 that are adjacent to disk 36 are curved arcuately inward so that the fluid path provided is substantially longitudinal. This permits smooth control of fluid flow through the valve. Poppet 34 is configured to move from a fully closed position (FIG. 5) in which top surface 37 of disk 36 abuts valve seat 28 and a fully open position (FIGS. 3 and 6) in which sidewall 38 abuts valve stop 46.

A return spring 42 is also received within control chamber 32. An upper end 41 of return spring 42 engages bottom surface 35 of poppet disk 36, and an opposing lower end 43 of the return spring engages valve stem 20 at end flange 12. Return spring 42 is configured to bias poppet 34 toward a closed position in which the poppet abuts valve seat 28, as illustrated in FIG. 5. When a force acts upon top surface 37 of disk 36 to compress return spring 42 and move poppet 34 away from valve seat 28, a control passage 44 is opened that extends from inlet passage 22 through orifice 30 and transversely between top surface 37 of poppet disk 36 and valve seat 28, then longitudinally into control chamber 32 through grooves 40 of sidewall 38. As the force created by pressure acting upon top surface 37 overcomes the opposing resistance of return spring 42 and continues to increase, the movement of poppet 34 away from valve seat 28, and thus the opening of control passage 44, will increase until sidewall 38 abuts against valve stop 46 when poppet 34 has reached the fully open position. FIG. 6 illustrates a partial cross-sectional view of control passage 44 when present exemplary control valve 10 is in the fully open position.

When poppet 34 is moved away from valve seat 28, fluid communication is provided between inlet passage 22 and control chamber 32, which is on a remote side of poppet 34 from valve seat 28 and in fluid communication with outlet passage 18. Thus, outlet passage 18 moves into and out of fluid communication with inlet passage 22 as poppet 34 slides within bore region 16c. As illustrated in FIG. 3, control valve 10 is also provided with a damping aperture 78 that is in fluid communication with inlet passage 22 and extends longitudinally away from poppet 34 within stem 20. Damping aperture 78 can reduce the undesirable effects of pressure fluctuations on the position of poppet 34 by damping the effect caused by the resistance to movement through inlet chamber 22 of fuel that is to be displaced out of control chamber 44 during the closure movement of the poppet, through which a resilient backward movement of the poppet after engagement with valve seat 28 upon closure is effectively prevented.

On the opposite side of poppet 34 from control chamber 32, a rod-shaped valve element 48 is slidably received within bore 16 of the valve stem 20. The diameter of the portion valve element 48 within bore region 16b is substantially the same as region 16b so that movement of the valve element can be guided within bore 16. The diameter of valve element 48 tapers from an exterior end 47 within bore region 16a to a substantially cylindrical interior end 49 within bore region 16b having a tip or nib 50 that extends toward poppet 34 through valve orifice 30. In exemplary embodiments, the distances that nib 50 extends past valve orifice 30, or the stroke of poppet 34, can be designed according to the dimensions of the control valve and the length of valve element 48.

Exterior end 49 of valve element 48 is mechanically joined, such as by brazing or welding for example, within a central aperture of an armature 52 that is slidably received within bore region 16a. Bore region 16a and armature 52 together define a clearance gap for wider end 49 of valve element 48 that serves to limit the extent of movement of the valve element within the bore, as will be described below. In exemplary embodiments, the components of control valve 10 can be configured to minimize the longitudinal length of this clearance gap to provide the valve with a very fast response time.

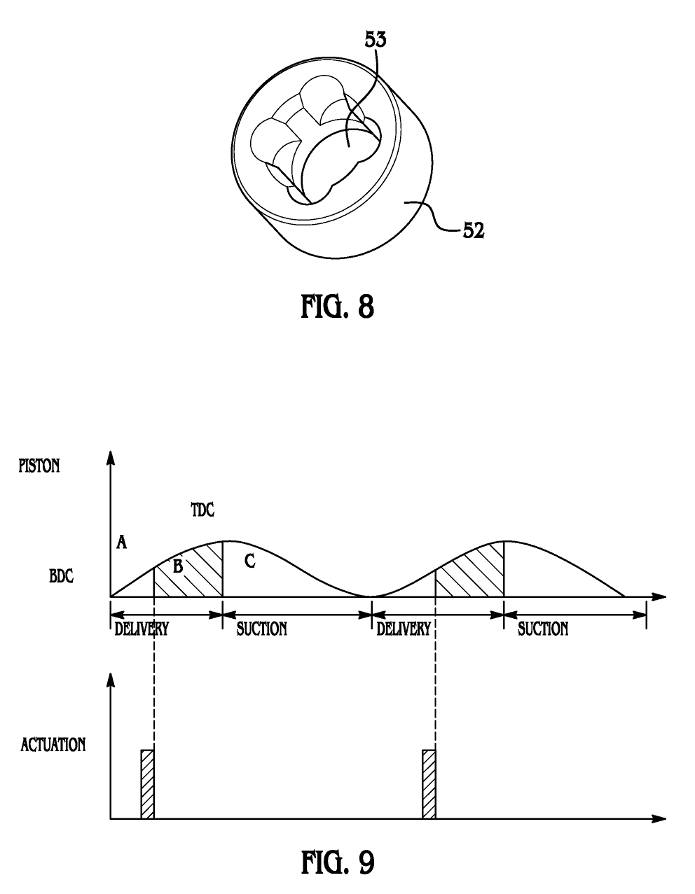

As illustrated in FIG. 8, armature 52 of the present exemplary embodiment has a generally annular shape and an aperture 53 extending therethrough for receiving valve element 48. In alternative exemplary embodiments, armature 52 can also be generally rectangular, star shaped, or another preferred shape.

Armature 52 is located proximate to an electrical actuator 54, which operates control valve 10. Actuator 54 comprises a solenoid coil 56 wound on a non-magnetic bobbin 58, which can be formed of a plastic in exemplary embodiments. In exemplary embodiments, solenoid coil 56 can be sealed off from fluid communication within the control valve to improve the body leakage performance and reduce hydro-carbon emissions carried by fuel vapors. A metal pilot plate 62 extends around valve stem 20 and closes the open end of actuator 54 to complete the magnetic circuit. Armature 52, which projects from bobbin 58 into bore region 16a, slidably moves within the bobbin, and valve element 48 moves jointly with the armature within bore region 16a.

A plastic enclosure 60 is molded around the coil and bobbin assembly and projects outwardly from there. An electrical connector 66 is formed at the remote end of the projecting section of enclosure 60. Electrical connector 66 has a pair of terminals that are connected to solenoid coil 56 by wires (not visible). A controller (not shown) that governs engine operation is coupled to electrical connector 66. To drive control valve 10, the controller produces a pulse width modulated (PWM) signal having a duty cycle that is varied to force poppet 34 toward a desired position in valve stem 20 as will be described. Moveable armature 52 is thus able to slide longitudinally within bobbin 58 in response to a magnetic field produced by application of electric current to the solenoid coil 56.

A magnetically conductive outer stop housing 64 is disposed within bobbin 58. Stop housing 64, preferably formed of plastic, has a central aperture 68. A stop spring 70 and a nose 72 are received within central aperture 68, with nose 72 extending therefrom into bore 16 and within an opening in exterior end 47 of valve element 48. When solenoid coil 56 is in its normal de-energized state, stop spring 70 acts to bias nose 72 to force valve element 48 toward control chamber 32 such that nib 50 extends through orifice 30 to engage top surface 37 of disk 36 and push poppet 34 away from valve seat 28 to open control valve 10.

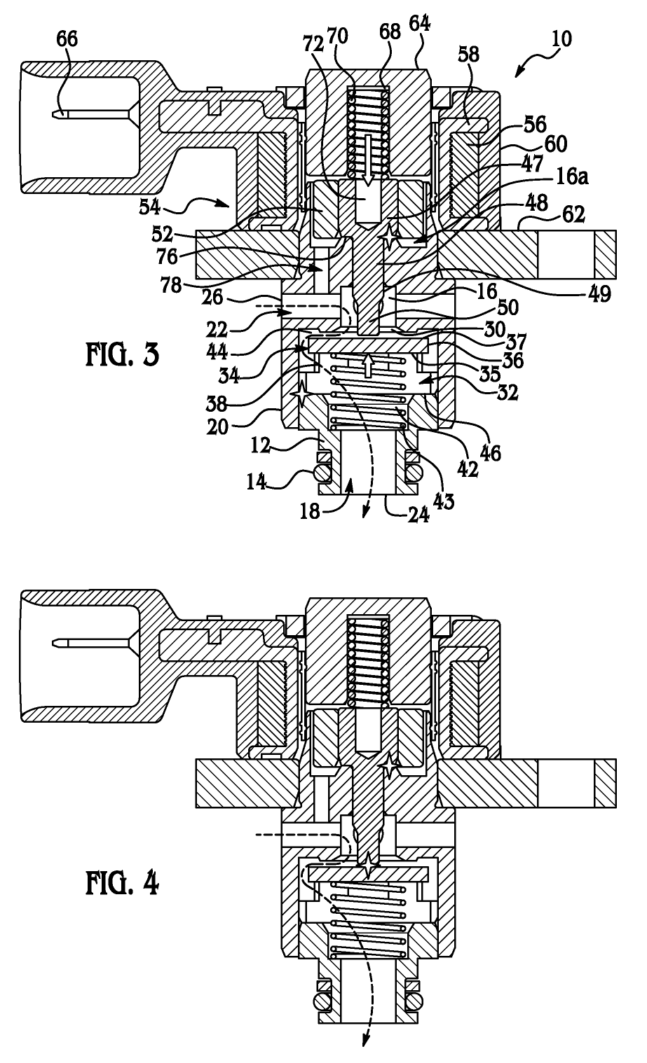

As illustrated in the exemplary embodiment of FIG. 4, because stop spring 70 acts on valve element 48 to provide a stronger biasing strength against top surface 37 of disk 36 than return spring 42 provides against bottom surface 35, the net force produced by the two springs acting on poppet 34 is greater in a direction which tends to move the poppet away from valve seat 28. As discussed above, this opens control passage 44, which provides fluid communication between inlet passage 22 and control chamber 32. Because the force from stop spring 70 prevents poppet 34 from moving toward valve seat 28, control valve 10 is normally disposed in an open position. Extension of valve element 48 into orifice 30 is limited by a valve element stop 76 of valve stem 20, which is defined between bore regions 16a and 16b. Stop 76 is engageable with exterior end 49 of valve element 48 to prevent top spring 70 from pushing the valve element beyond a fully extended position when solenoid coil 56 is de-energized.

As illustrated in FIG. 5, when solenoid coil 56 is energized with electricity supplied via connector 66, a magnetic field indicated by flux lines 74 is produced that flows through armature 52 and operates to attract the armature to move toward stop housing 64. Because valve element 48 is not coupled to poppet 34, when armature 52 moves toward stop housing 64, the armature acts to retract the valve element toward the stop housing so that it disengages from poppet 34. When solenoid coil is energized, armature 52 will move toward stop housing 64 until valve element 48 engages the stop housing in a fully retracted position, as illustrated in FIG. 5.

With valve element 48 then no longer biasing poppet 34 away from valve seat 28, the force from return spring 42 can bias the poppet in the opposite direction toward the valve seat and to the closed position. Movement of armature 52 and valve element 48 away from valve seat 20 in this fashion thus permits poppet 34 to abut valve seat 28 and close control passage 44, thereby terminating fluid communication between the outlet passage 18 and inlet passage 22, as illustrated in FIG. 5. The force from return spring 42 prevents poppet 34 from moving away from valve seat 28 and maintains control valve 10 in the closed state, unless pressure in inlet passage 22 is high enough to overcome the spring resistance.

Operation of control valve 10 of the present exemplary embodiment during the load, spill, and delivery stages of fuel metering cycle are illustrated in FIGS. 3-5 and will now be described. During the metering cycle, the forces due to the fluid pressures acting on poppet 34 work in conjunction with the forces of the dual-springs to provide control valve 10 with an extremely precise response time. Specifically, fluid pressure from fuel that is fed from the fuel tank builds in inlet passage 22 to act upon top surface 37 of disk 36, and fluid pressure from fuel that is supplied or pumped from the supply pump chamber builds in control chamber 32 to act upon bottom surface 35. Thus, fluid pressure in inlet passage 18 during the load spill stages of the metering cycle tends to move poppet 34 away from valve seat 28 and open the valve, and fluid pressure in control chamber 32 during the spill and delivery stages tends to move the poppet toward the valve seat and close the valve.

As described above, when control valve 10 is not being activated by electric current applied to the solenoid actuator 54, stop spring 70 overcomes the weaker force of return spring 42 to actuate valve element 48 to bias poppet 34 away from valve seat 28 and maintain the valve in an open condition. This provides for fluid communication between inlet passage 22 and outlet passage 18 so that fuel can be loaded into the supply pump. With the valve open, fluid from the fuel tank can flow to inlet passage 22 and through control passage 44 and control chamber 32 to outlet passage 22 and into the pump. Additionally, while the extension of valve element 48 pushing poppet 34 away from valve seat 28 is limited by element stop 76, the heightened fluid pressure in inlet passage 22 caused by fuel flow from the fuel tank can act on top surface 37 of disk 36 to disengage the poppet from the valve element and move the poppet further from valve seat 28. In other words, when the pump is loading fuel from the fuel tank, fluid pressure in inlet passage 22 can further compress return spring 42 to move poppet 34 away from valve seat 28 until the force of the return spring counter balances the force produced by the fuel that is loading or until the poppet is stopped by valve stop 46 in a fully opened position. Thus, exemplary control valve 10 provides a poppet over-stroke to permit higher fuel flow rates during fuel loading, as shown in FIG. 3.

In exemplary embodiments, poppet 34 can be configured to move further from valve seat 28 and/or more quickly in response to a given amount of fluid pressure in inlet passage 22 by inserting a weaker return spring. Similarly, using a stronger return spring will decrease the distance and/or the rate at which that poppet 34 moves for a given amount of inlet fluid pressure. Thus, in exemplary embodiments, control valve 10 can be configured so that control passage 44 can be maintained at a size that permits the desired fuel flow rate to occur through the valve during fuel loading.

Once the pump has completed a suction stroke and loaded fuel from the fuel tank, it awaits a signal from the ECU instructing it to begin the delivery stage and inject fuel into the cylinders. As discussed, the ECU measures factors such as engine load, calculates the amount of fuel needed, and sends a signal instructing the supply pump to begin pumping fuel at the precise moment the angle of the cam operating on the supply pump causes the supply chamber to have the desired volume of fuel for the next delivery. Nevertheless, unless the full piston stroke of the supply pump will be needed for the next delivery, some fuel from the chamber must be spilled back through the valve to the fuel inlet line during the discharge stroke of the supply pump. Therefore, control valve 10 must remain open during this spill stage until the supply pump is instructed to begin pumping. This is accomplished by keeping solenoid coil 56 de-energized during the spill stage. As discussed above, when control valve 10 is not being activated by electric current applied to the solenoid actuator 54, stop spring 70 overcomes the weaker force of return spring 42 to actuate valve element 48 to bias poppet 34 away from valve seat 28 and maintain the valve in an open condition. Thus, so long as the pressure caused by return flow from the supply chamber is not high enough to overcome the resistance of stop spring 70, control valve 10 remains open and the supply pump can discharge fuel through control passage 44 to the fuel inlet line until the supply chamber contains the desired amount of fuel for delivery in the delivery stage, as illustrated in FIG. 4.

When signaled by the ECU, the supply pump must rapidly transition into the delivery of high-pressure fuel into the cylinders. Thus, because control passage 44 creates a fluid path that reduces the pressure within control chamber 32, the valve must rapidly close the control passage so that the pump can supply high-pressure fuel flow to the engine. To close the valve, the ECU sends a signal to controller 66 to energize solenoid coil 56, which attracts armature 52 toward stop housing 64 and retracts valve element 48 from poppet 34. The duration of the pulse width sent from controller 66 to retract valve element 48 need not extend beyond the moment the supply pump begins delivery fuel to the common rail at the desired high-pressure level. When nib 50 of valve element 48 no longer projects through orifice 30 and past valve seat 28, the force of return spring 42 acts to bias poppet 34 against the valve seat to terminate fluid flow between inlet passage 22 and the control chamber 32, as illustrated in FIG. 5. Thus, the fluid pressure within control chamber 32 can increase to the desired high-pressure level so that the high-pressure fuel flow can then be directed to the engine at the desired high pressure through a fuel rail (such as common rail 8 in the exemplary GDI system of FIG. 1) that is open only when the supply pressure is above the high operating pressure of the rail. Even if solenoid coil 56 is de-energized at this point, the valve will remain closed until the pump stage is complete due to the high-pressure fuel flow within control chamber 32 acting on bottom surface 35 of disk 36.

In exemplary embodiments, valve control 10 need not be required to wait for solenoid coil 56 to be energized before the switch from the spill stage to the delivery stage is complete. Rather, as the pump beings to push fuel flow before solenoid coil 56 is fully energized, once the pump begins pushing fuel flow at a sufficiently high pressure, the fluid pressure in control chamber 32, in combination with force provided by return spring 42, can act on bottom surface 35 of disk 36 to overcome the strength of stop spring 70 and force the poppet to engage valve seat 28. In this exemplary embodiment, the high-pressure pumping acts to close the valve and terminate communication between inlet passage 18 and control chamber 32 before solenoid actuator 54 has been fully energized.

The present exemplary embodiment allows the transition period to the delivery stage to be achieved with much tighter tolerances. Moreover, control valve 10 will remain closed to maintain fuel pressurization until the delivery stage in completed even if solenoid coil 56 is de-energized during the injection event, as the fuel pressure within control chamber 32 during will combine with the force of return spring 42 to overcome the force of stop spring 70 and prevent poppet 34 from being moved away from valve seat 28. Thus, the valve will be maintained in the closed state until fuel is no longer being supplied by the pump at a sufficiently high-pressure level.

When the pump has completed the delivery stage and is no longer pushing fuel into the cylinders, the metering cycle is ready to transition back to the load stage. The unique design of valve control 10 also allows for a rapid switch from the delivery stage to the load stage, even where solenoid coil 56 is not fully de-energized at the outset of the load stage. Specifically, even if solenoid actuator 54 is activated and control passage 44 is closed due to the force of return spring 42, the fuel tank can begin feeding fuel through the fuel inlet line into inlet passage 22, and when the fluid pressure in the inlet passage creates a force acting on top surface 37 of disk 36 that is sufficient to overcome the force exerted by return spring 42 on bottom surface 35, the resultant net force on poppet 34 will urge it to move away from valve seat 28. Thus, the valve will open to permit fuel from the fuel tank to flow to inlet passage 22 and through control passage 44 and control chamber 32 to outlet passage 18 and into the pump, even if solenoid coil 56 has not yet been de-energized.

Therefore, the present exemplary control valve 10 has particular use in regulating fuel pressure and flow rate in a GDI fuel system for an internal combustion engine in which the timing and amount of fuel delivery requires precise control and can vary according to operating conditions (for example, the exemplary fuel injection system 1 of FIG. 1). In such a system, the control valve must undergo many rapid metering cycles, and therefore switch between opened and closed states very rapidly many times, during each cycle of the engine to control pressure at the fuel pump outlet. The relationship between the forces due to pressurized fluid flow and the forces provided by the dual springs provides exemplary flow control valve 10 with several features that can contribute to the ability to operate under very fast pressure cycling requirements. First, exemplary control valve 10 can be configured so that the force provided by return spring 42 nearly balances the force of valve element 48 provided by stronger stop spring 70 when solenoid coil 56 is de-energized. Thus, activation of solenoid coil 56 (or fluid pressure in control chamber 32) at the outset of the delivery stage can operate to close the valve very quickly so that delivery of high-pressure fuel to the common rail can occur very rapidly. Second, even if solenoid coil 56 is energized at the outset of the load stage, fuel being fed from the fuel tank can create a fluid pressure in inlet passage 22 that causes the valve to crack open and thus provide a fluid path so that fuel can be loaded in the pump before the solenoid actuator is de-energized. Third, the poppet and the return spring can be configured and assembled independently from the valve element and stop spring within the control valve to provide the precise pressure, flow rates, cycle response times desired by metering cycles of the electrohydraulic system, with low variation in a simple, easy-to-manufacture, low-mass design that need not require calibrations. Moreover, in exemplary embodiments of the present invention, the moving components (e.g., the valve element, the armature, and the poppet) can be configured with smaller or relational geometries and tighter clearances within the longitudinal bore to reduce the switching response time, reduce the overall length of the control valve.

The metering cycle of the control valve of the present exemplary embodiment is illustrated graphically in FIG. 9. Letter A indicates the spill stage, during which the supply chamber has been loaded and the solenoid actuator has yet to be energized. In this stage, as the angle of the cam is changing to cause the piston to decrease the size of the supply chamber, the fuel that is consequently discharged from the supply pump chamber is spilled back into the fuel line through the control valve being held open by the valve element. As the solenoid actuator is energized as the end of stage A and the valve closes, the supply pump begins the delivery stage in the section of the graph indicated by letter B, pumping high-pressure fuel to the cylinders until the desired amount of fuel has been delivered. At the completion of stage B, the load stage, indicated by letter C, then begins as the solenoid actuator is de-energized. Fuel is fed into the pump in this stage even before the solenoid actuator is fully de-energized. In exemplary embodiments of the present invention, the response time of switching between the three stages of the metering cycle can take place in milliseconds, with tolerances in the microseconds. Particularly, in exemplary embodiments, the de-energizing of the solenoid actuator need not occur simultaneously with the transition from pump stage B to load stage C. Rather, the actuator can be de-energized during pump stage B, in which case the high-pressure fuel within the control chamber acts on the poppet to keep the control valve closed during delivery; alternatively, the actuator can be de-energized during load stage C, in which case the force of the pressure from the fuel being fed from the fuel tank within the inlet passage can act on the poppet to open the control valve so that the supply pump can load fuel while the actuator remains energized.

While the invention has been described with reference to exemplary embodiments, it will be understood by those skilled in the art that various changes may be made and equivalents may be substituted for elements thereof without departing from the scope of the invention. For example, in accordance with an exemplary embodiment of the present invention, the interface can be accomplished by engaging a spherical flare on the outer end of an end cone assembly with a spherical end of a conduit tube. In addition, many modifications may be made to adapt a particular situation or material to the teachings of the invention without departing from the essential scope thereof. For example, in accordance with another exemplary embodiment of the present invention, the interface at the junction between a conduit and a spherical component can further comprise a flex-joint. Therefore, it is intended that the invention not be limited to the particular embodiments disclosed as the best mode contemplated for carrying out this invention, but that the invention will include all embodiments falling within the scope of the present application.

What is claimed is:

1. A control valve for a gas direct injection fuel delivery system, the control valve comprising:
a valve body having a first fluid path, a second fluid path, and a valve seat providing fluid communication therebetween;
a poppet movably received within the valve body, the poppet being capable of movement between a first position and a second position, the poppet sealing the valve seat to block fluid communication between the first fluid path and the second fluid path when disposed in the first position, the poppet permitting fluid communication between the first fluid path and the second fluid path as the poppet moves from the first position to the second position, the poppet being configured so that a pressure in the first fluid path produces a force that tends to move the poppet toward the second position and a pressure in the second fluid path produces a force that tends to move the poppet toward the first position; and
an actuator disposed within the valve body and configured to transition between an activated and a de-activated state, the actuator preventing the poppet from being disposed in the first position when in the de-activated state and the pressure in the second fluid path does not exceed the pressure in the first fluid path by at least a first pressure differential, the actuator permitting the poppet to be disposed in the first position when in the activated state.

2. The control valve of claim 1, further comprising an aperture in fluid communication with the first fluid path, the aperture extending longitudinally away from the poppet within the valve body.

3. The control valve of claim 1, wherein the valve body further comprises a bore extending longitudinally therethrough, a first port, and a second port, and wherein the first fluid path provides fluid communication between the first port and the bore and the second fluid path provides fluid communication between the second port and the bore.

4. The control valve of claim 3, wherein the first fluid path extends transversely from the first port through the valve body into the bore.

5. The control valve of claim 4, wherein the poppet is received within the bore of the valve body and is slidable therein between engagement with the valve seat in the first position and engagement with a second valve seat in the second position.

6. The control valve of claim 5, wherein the poppet defines a control chamber within the bore on a side of the poppet remote from the valve seat.

7. The control valve of claim 6, wherein the poppet further comprises a disk proximate the valve seat and a sidewall extending longitudinally therefrom into the control chamber, the disk and the sidewall forming a plurality of grooves providing fluid communication longitudinally therethrough.

8. The control valve of claim 7, wherein the disk has a first surface proximate the valve seat and a second surface remote from the valve seat and proximate the control chamber.

9. The control valve of claim 8, wherein a control passage extending transversely between the valve seat and the first surface opens as the poppet moves from the first position to the second position, and wherein the control passage provides fluid communication between the first fluid path and the control chamber.

10. The control valve of claim 1, wherein a return spring extends between the poppet and the second fluid path, and wherein the return spring exerts a first spring force that biases the poppet toward the first position to seal the valve seat.

11. The control valve of claim 10, wherein the poppet is configured to move toward the second position to provide fluid communication between the first fluid path and the second fluid path when the pressure in the first fluid path exceeds the pressure in the second fluid path by at least a second pressure differential that is greater than the first spring force.

12. The control valve of claim 11, wherein the poppet is configured to move into the second position when the pressure in the first fluid path exceeds the pressure in the second fluid path by at least a third pressure differential that is greater than the second pressure differential.

13. The control valve of claim 12, further comprising a valve element movably received within the bore proximate the poppet on a side of the poppet remote from the control chamber, and wherein the valve element is capable of movement between an extended position in which a nib portion of the valve element projects through the valve seat to prevent the poppet from being disposed in the first position and a retracted position in which the valve element permits the poppet to be disposed in the first position.

14. The control valve of claim 13, wherein the actuator is electronically controlled and comprises a solenoid coil and an armature that is operatively coupled to the valve element.

15. The control valve of claim 14, wherein the armature is configured to move the valve element into the retracted position in response to an electromagnetic field produced by the solenoid coil when the actuator is in the activated state.

16. The control valve of claim 15, wherein a stop spring exerts a stop spring force that biases the valve element toward the extended position.

17. The control valve of claim 16, wherein the stop spring force exceeds the return spring force so that the valve element prevents the poppet from being disposed in the first position when the actuator is in the de-activated state and the pressure in the second fluid path does not exceed the pressure in the first fluid path by at least the first pressure differential.

18. The control valve of claim 17, wherein the poppet is configured to move into the first position when the actuator is in the de-activated state and the pressure in the second fluid path exceeds the pressure in the first fluid path by at least the first pressure differential.

19. The control valve of claim 18, wherein the poppet is configured to move into the first position when the actuator is in the activated state and the pressure in the first fluid path does not exceed the pressure in the second fluid path by at least the second pressure differential.

20. The control valve of claim 3, wherein the first port is fluidly connected to a fuel reservoir having a low-pressure feed pump that is configured to supply liquid fuel to the first fluid path at a pressure approximately 2-6 bar.

21. The control valve of claim 20, wherein the second port is fluidly connected to an inlet and an outlet of a high-pressure supply pump

22. The control valve of claim 21, wherein the outlet of the high-pressure supply pump is configured to supply liquid fuel to the second fluid path at a pressure of approximately 120-250 bar.

23. The control valve of claim 22, wherein the high-pressure supply pump comprises a positive displacement piston pump in which rotation of an engine camshaft causes a piston to alternate between moving into a fuel chamber of the piston pump to decrease the volume of the fuel chamber and out of the fuel chamber to increase the volume of the fuel chamber.

24. The control valve of claim 23, wherein movement of the piston out of the fuel chamber creates a partial vacuum that draws fuel being supplied by the low-pressure feed pump to the first fluid path through the valve seat and the inlet of the high-pressure supply pump to the fuel chamber when the poppet is not disposed in the first position.

25. The control valve of claim 24, wherein movement of the piston into the fuel chamber causes fuel stored within fuel chamber to discharge through the outlet into the second fluid path and spill through the valve seat into the first fluid path when the actuator is de-activated and the poppet is not disposed in the first position.

26. The control valve of claim 25, wherein the outlet of the high-pressure supply pump is further coupled to a common fuel rail that feeds a plurality of individual fuel injectors.

27. The control valve of claim 26, wherein fuel can be pressurized within the fuel chamber and supplied by the high-pressure supply pump through the outlet to the common fuel rail when the poppet is disposed in the first position.

28. The control valve of claim 27, wherein the common rail is open only when the pressure of the fuel being supplied by the high-pressure supply pump is above the high operating pressure of the rail.

29. The control valve of claim 28, wherein the timing and duration of activation of the actuator and the operation of the high-pressure supply pump are controlled by an electronic control unit.

30. A method of controlling fluid flow between a fuel reservoir and a plurality of fuel injectors, the method comprising:
biasing a valve member to a first position with a biasing force in a first direction, a first fluid path and a second fluid path being in fluid communication with each other when the valve member is in the first position, the first fluid path being in fluid communication with the fuel reservoir and the second fluid path being in fluid communication with the plurality of fuel injectors;
isolating the first fluid path from the second fluid path by moving the valve member in a second direction opposite to the first direction to a second position when a fluid pressure in the second fluid path exceeds a predetermined value sufficient to overcome the biasing force in the first direction;
reducing the biasing force in the first direction by moving a rod away from a first rod position, a tip of the rod making contact with the valve member when the rod is in the first rod position and the valve member is in at least the first position; and
moving the valve member in the first direction to a third position when a fluid pressure in the first fluid path exceeds a predetermined value sufficient to overcome the fluid pressure in the second fluid path and a spring providing a biasing force to the valve member in the second direction, the first fluid path and the second fluid path being in fluid communication with each other when the valve member is in the third position.
